(19) United States
(12) Patent Application Publication
(10) Pub. No.: US 2025/0286874 A1
(43) Pub. Date: Sep. 11, 2025

(54) Dynamically-Enrolled Authentication Tokens for Pooled Computing Devices

(71) Applicant: Zebra Technologies Corporation, Lincolnshire, IL (US)

(72) Inventors: Andrew J. Pekarske, Mundelein, IL (US); Nader Newman, Burlington (CA); Lawrence H. Aron, Cranberry Township, PA (US); James J. O'Hagan, McHenry, IL (US)

(21) Appl. No.: 18/598,510

(22) Filed: Mar. 7, 2024

(51) Int. Cl. H04L 9/40

(52) U.S. Cl. CPC H04L 63/0807

(57) ABSTRACT

A method includes: storing an account identifier and authentication data associated with the account identifier; receiving, from a client computing device, a token identifier, requesting the authentication data from the client computing device; in response to receiving the authentication data, generating token enrollment data associating the token identifier with the account identifier; and transmitting the token enrollment data for storage in association with the client computing device.

### BACKGROUND

Accessing enterprise applications and/or other services deployed via computing devices may require logging into such devices with provisioned accounts. For example, logging in may involve providing a user name, a password, and in some cases additional information for multi-factor authentication (e.g., biometric data or the like). In some environments, the provision of such authentication data may be time-consuming, e.g., as a result of the use of shared computing devices.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a system for deploying enterprise applications.

FIG. 2 is a diagram illustrating an authentication token for use in the system of FIG. 1.

FIG. 3 is a flowchart of dynamic enrollment of authentication tokens.

FIG. 4 is a diagram illustrating an example performance of blocks 305 to 330 of the method of FIG. 3.

FIG. 5 is a diagram illustrating an example performance of blocks 335 to 355 of the method of FIG. 3.

FIG. 6 is a diagram illustrating a further example performance of the method of FIG. 3.

FIG. 7 is a diagram illustrating another example performance of the method of FIG. 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method, comprising: storing an account identifier and authentication data associated with the account identifier; receiving, from a client computing device, a token identifier; requesting the authentication data from the client computing device; in response to receiving the authentication data, generating token enrollment data associating the token identifier with the account identifier; and transmitting the token enrollment data for storage in association with the client computing device.

Additional examples disclosed herein are directed to a computing device, comprising: a communications interface; and a processor configured to: store an account identifier and authentication data associated with the account identifier; receive, from a client computing device, a token identifier; request the authentication data from the client computing device; in response to receiving the authentication data, generate token enrollment data associating the token identifier with the account identifier; and transmit the token enrollment data for storage in association with the client computing device.

Further examples disclosed herein are directed to a computing device, comprising: a communications interface; an output device; and a processor configured to: obtain a token identifier and token enrollment data; determine that the token identifier is associated with a second computing device authenticated to access a service using an account identifier; generate a prompt via the output device; receive, via the prompt, a command to transfer access to the service from the second computing device to the computing device; in response to the command, access the service using the token enrollment data.

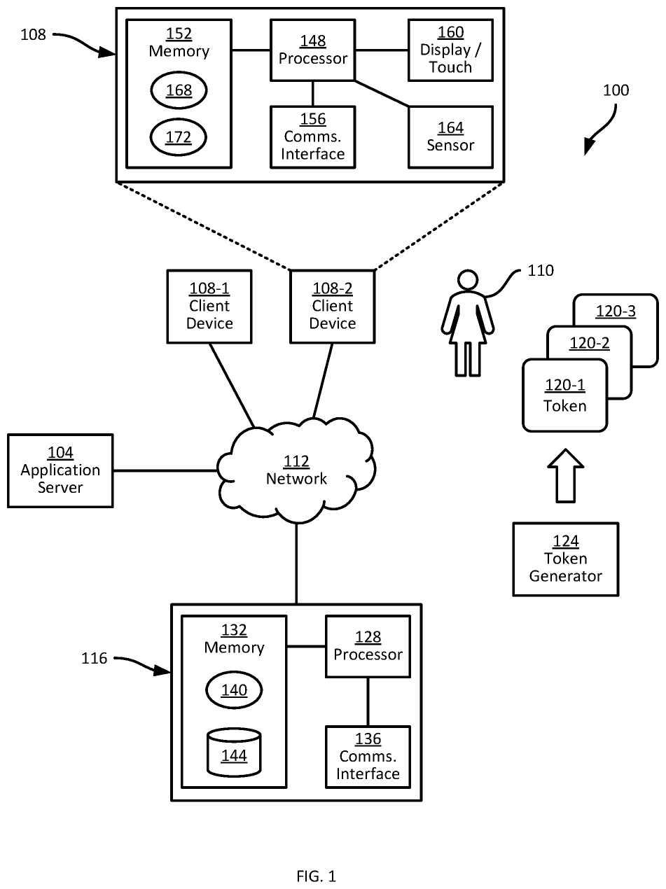

FIG. 1 shows a system 100 for deploying one or more enterprise software applications, e.g., hosted by an application server 104 and accessible to a plurality of client computing devices (also referred to as client devices). Two example client devices 108-1 and 108-2 are shown in FIG. 1, and are collectively referred to as the client devices 108, or generically as a client device 108. The system 100 can include a greater number of client devices 108 than those shown in FIG. 1.

For example, the application server 104 can host a package tracking application configured to collect identification information, location information and the like corresponding to packages or other items handled in an order-fulfillment facility. The client devices 108 may, for example, be operated by staff at the facility such as an operator 110 to capture the above information from labels or the like affixed to packages, and transmit captured information to the application server 104 for further processing. A wide variety of other enterprise applications can also be implemented in the system 100 by the application server 104 and/or other application servers, enabling various functions to be performed in cooperation with the client devices 108, which can communicate with the application server 104 and/or each other via a network 112 (e.g., a suitable combination of local and wide-area networks). Other enterprise applications implemented by the system 100 can include a timekeeping application for staff of the facility, email and/or other messaging applications, and the like.

To make use of functionality hosted or otherwise managed by the application server 104, a client device 108 can execute a dedicated local application, a web browser, or the like, configured to communicate with the application server 104 according to a predetermined protocol, application programming interface (API), or the like. Access to the application server 104 by a client device 108 is contingent on the operator of the client device 108 (e.g., the operator 110) completing an authentication process. The system 100 can, for example, include an authentication server 116 connected with the network 112, and configured to store or otherwise access account records corresponding to staff in the facility, such as the operator 110. Each account record may, for example, indicate which enterprise applications and/or functions within such applications the corresponding user has permission to access, at which times, and the like.

The authentication process serves to confirm that a given client device 108 is operated by a person with an account provisioned at the authentication server 116, according to which access of the enterprise application(s) by the client device 108 can then be managed. To complete the authentication process, the operator 110 can provide a username and password, and/or other suitable authentication data such as a fingerprint or other biometric data, via a client device 108, for transmission to the authentication server 116. The authentication server 116 can determine whether the authentication data received from the client device 108 matches reference authentication data stored at the server 116, and if the authentication data does match the reference data, provide information (e.g., redirection commands, encryption keys, or the like) to the client device 108 and/or application server 104 that grants the client device 108 access to certain functionality hosted at the application server 104. Successful authentication, in other words, results in an association, e.g., maintained at the authentication server 116, between the operator 110 and a given client device 108 that permits the operator 110 to access various functionality within the system 100 via that client device 108.

The client devices 108 in the system 100 may be deployed in one or more shared pools of devices. For example, at the start of a shift or other time period, the operator 110 may select a client device 108 from a pool of available devices 108 (e.g., disposed in a rack of charging docks or the like). At a later time period, e.g., the next shift the operator 110 works, the operator 110 may select a different client device 108 from the shared pool. Further, the operator 110 may interact with distinct client devices 108, e.g., to perform different functions and/or to perform functions in different areas of a facility. For example, an environmentally-controlled area of a facility may be equipped with a dedicated pool of client devices 108, and upon entering the environmentally-controlled area, the operator 110 may switch from a previous client device 108 to a client device from the dedicated pool. Switching devices may involve re-authenticating, to enable continued access to the application server 104 from the new client device 108.

The shared deployment of the client devices 108 can result in operators providing authentication data repeatedly at different computing devices over the course of a shift, week, or other time period. The repeated provision of authentication data is time-consuming, and certain authentication data, such as usernames and passwords, may also be prone to typographical errors or the like, increasing the time consumed by re-authentication.

Certain systems implement technologies to mitigate the burden of re-authentication by the operator 110. For example, some systems may provide the operator 110 with an authentication fob (e.g., a radio-frequency identification, RFID, device) or the like. The fob may have a unique identifier, e.g., encoded thereon, and the unique identifier may also be provisioned at the authentication server 116 in association with the account record corresponding to the operator 110. The operator 110 may therefore be permitted to authenticate by presenting the fob to a client device 108, instead of providing a username and password and/or other authentication data. The use of a fob or the like to reduce the time spent by the operator 110 to authenticate via client devices 108, however, increases the complexity of the system 100. For example, provisioning the authentication server 116 with the unique identifiers of the fobs, assigning the fobs to the operator 110 and other staff of the facility, and the like, may increase the technological and human resources involved in operating the system 100. In addition, if a fob is lost or damaged, an operator 110 may be required to return to the time-consuming provision of authentication data to successive client devices 108 until a replacement fob is procured and configured at the authentication server 116.

The system 100 implements certain functionality to reduce the time involved in authentication with various client devices 108 by the operator 110, while also mitigating increases in complexity to the system 100 relative to systems such as those employing operator-specific fobs or other devices as mentioned above.

The system 100 provides a plurality of token identifiers, which in the present example are provided on physical tokens 120-1, 120-2, 120-3, and so on (the system 100 can include a greater number of tokens 120 than those shown in FIG. 1) such as badges, wristbands, or the like. The token identifiers are not initially associated with a particular operator, and in some examples are not initially known to the authentication server 116. That is, the authentication server 116 need not be configured to store the token identifiers prior to their use by operators, and even in embodiments where the token identifiers are stored at the authentication server 116 prior to use, the token identifiers need not be stored in connection with any particular account maintained at the authentication server 116.

The authentication server 116 and the client devices 108 are configured to communicate to dynamically associate an arbitrarily selected token identifier with the operator 110 (or any other specific operator). In other words, in contrast with the fobs mentioned above, which are assigned to specific operators and enrolled at the authentication server 116 prior to use, the token identifiers deployed on the tokens 120 can be enrolled substantially in real time. Once a token identifier has been dynamically enrolled in association with the operator 110 at the authentication server 116, the operator 110 can use that token identifier to authenticate with one or more client devices 108, bypassing the provision of other authentication data under at least some conditions. The time involved in authenticating may therefore be reduced for the operator 110, and a corresponding increase in provisioning complexity at the authentication server 116 may be mitigated. Further, the dynamic enrollment of token identifiers may facilitate recovery from lost or damaged tokens 120, as the operator 110 may arbitrarily retrieve a different token 120 and repeat the dynamic enrollment process.

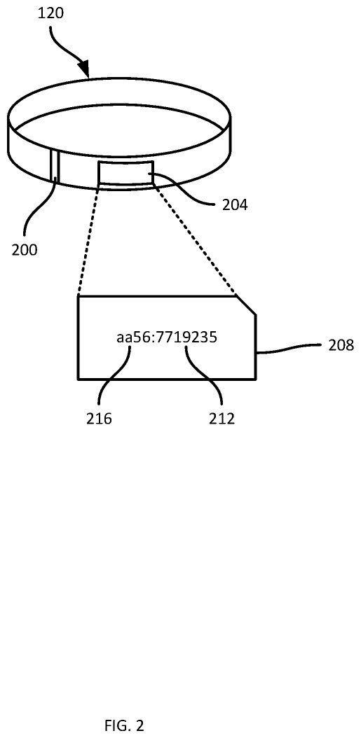

The tokens 120 can be generated or otherwise configured by a token generator 124. For example, in implementations in which the tokens 120 are wristbands, the token generator 124 can include a printer, RFID encoding device, or the like, configured to print and/or otherwise encode a token identifier on each token 120. For example, the token generator 124 can be configured to print a machine-readable indicium such as a barcode onto each token 120. Each barcode can encode a distinct token identifier, such that each token 120 is uniquely identified relative to the other tokens 120. Certain other features of the tokens 120 are discussed below in connection with FIG. 2.

Certain components of the authentication server 116 and the client devices 108 are also shown in FIG. 1. The authentication server 116 includes a processor 128 (e.g., a central processing unit (CPU), graphics processing unit (GPU), and/or other suitable control circuitry, microcontroller, or the like). The processor 128 is interconnected with a non-transitory computer readable storage medium, such as a memory 132 including volatile memory elements (e.g. Random Access Memory or RAM) and/or non-volatile memory elements (e.g. read only memory or ROM, Electrically Erasable Programmable Read Only Memory or EEPROM, flash memory). The memory 132 can store computer-readable instructions, execution of which by the processor 128 configures the processor 128 to perform various functions. The authentication server 116 also includes a communications interface 136 enabling the server 116 to exchange data with other computing devices, such as the client devices 108 and the application server 104, over the network 112.

The computer-executable instructions stored in the memory 132 include an authentication application 140, execution of which by the processor 128 configures the server 116 to control access to the authentication server 104 and/or other elements of the system 100 by the operator 110 via the client devices 108. The application 140 also configures the server 116 to dynamically enroll token identifiers in association with operators (such as the operator 110), permitting the operator 110 to bypass the provision of authentication data to access system functionality under some conditions. The memory 132 can also maintain a repository 144 of account records and token enrollment data, example contents of which are discussed later herein.

Certain components of the client device 108-2 are illustrated in FIG. 1. The client devices 108 need not have the same form factors or hardware configurations as one another, and the specific instances of the illustrated components may therefore vary. Each client device 108 includes a processor 148 (e.g., a CPU, GPU, and/or other suitable control circuitry, microcontroller, or the like), and a non-transitory computer-readable medium such as a memory 152. Each client device 108 also includes a communications interface 156 configured to communicate with other computing devices via the network 112, such as the authentication server 116 and the application server 104. Each client device 108 further includes one or more input devices and one or more output devices, such as a display and touch screen assembly 160. The client devices 108 can include other input/output devices, such as speakers, microphones, keypads, and the like. Each client device 108 also includes a sensor 164, such as a camera, a barcode scanning assembly, an RFID reader, or the like. As discussed below, the sensor 164 can be controlled to capture token identifiers, e.g., from the tokens 120, for use in the dynamic enrollment process described herein.

The memory 152 stores computer-readable instructions, e.g., including an authentication application 168 (which may be implemented as a component of an operating system of the device 108, in some examples). The authentication application is executable by the processor 148 to implement certain functions, e.g., in cooperation with the server 116, to dynamically enroll token identifiers and authenticate operators. The memory 152 can also store other applications, such as an enterprise client application 172 configured to communicate with the application server 104. Establishing communication between the application 172 and the application server 104 may include invoking the application 168 in order to authenticate the client device 108 with the authentication server 116.

Turning to FIG. 2, an example token 120 is illustrated. The token 120 is implemented in the form of a wristband in this example, although in other examples the tokens 120 can have other formats. The token 120 can include a fastener 200, such as overlapping adhesive tabs used to form a strip into the illustrated loop, a one-way ratcheting fastener, or the like. In some examples, the fastener is not readily removable without damaging the wristband, such that re-use of the wristband after removal is inconvenient.

The token 120 includes a data carrier 204 printed, embedded, or otherwise affixed to the wristband, and carrying a token identifier that distinguishes the token 120 from other tokens 120. In some examples, the data carrier 204 can be co-located with the fastener 200, such that attempts to unfasten the wristband render the data carrier 204 unusable (e.g., by corrupting the information encoded by the carrier 204). The data carrier 204 can, in other words, be tamper-evident. The data carrier 204 can include a barcode encoding the token identifier, an RFID circuit storing the token identifier, a plain-text rendering of the token identifier, a graphic with visual properties defining the token identifier, or the like. For example, the data carrier 204 can encode a token payload 208 that includes a token identifier 212. In this example the token ID 212 is an alphanumeric string “7719235”, although other forms of token ID are also contemplated. The payload 208 can also include, as shown in FIG. 2, an auxiliary identifier 216 “aa56” that is common to all tokens 120, or to a subset of the tokens 120. The auxiliary identifier 216 can be a manufacturer-specific string, a facility-specific string, or the like, that distinguishes the data carriers 204 of the tokens 120 from the various other data carriers (e.g., other barcodes and the like) present in the facility.

The token ID 212 can be randomly generated, e.g., by the token generator 124 or another computing device in communication with the token generator 124. In some examples, the token ID 212 can be one of a sequential series of token identifiers. For example, the token generator 124 can be controlled to print a batch of wristbands for a given shift, day, week, or the like, encoding token IDs 212 in the form of sequential numbers on each wristband. As will be apparent from the discussion below, prior to dynamic enrollment of a given token 120, the token ID 212 does not need to be provided to the authentication server 116, nor does the token ID 212 need to be associated with any particular operator at the authentication server 116.

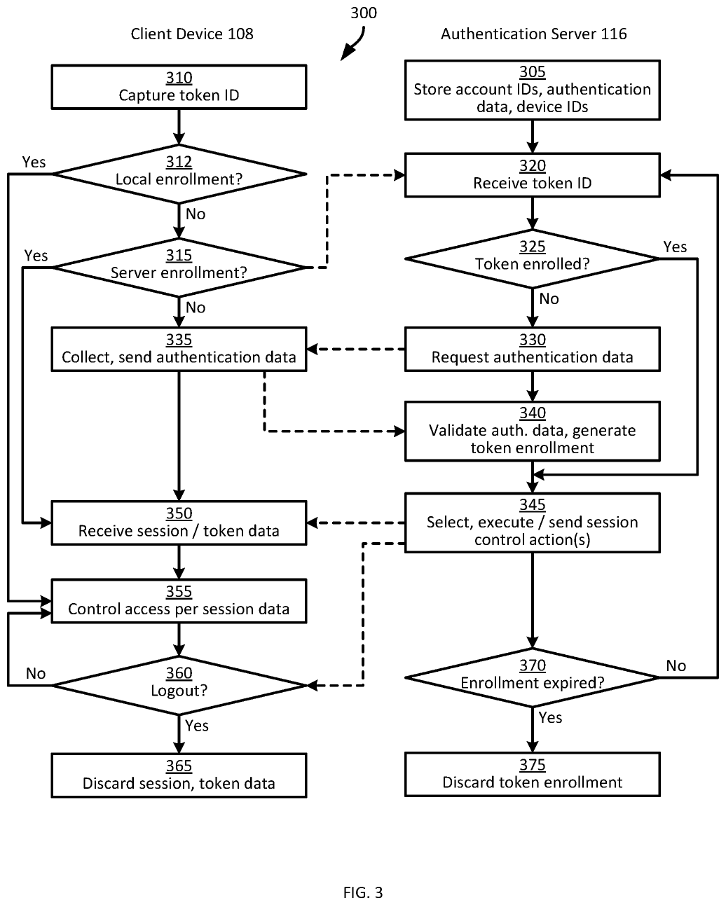

Turning to FIG. 3, a method 300 for dynamically enrolling authentication tokens is illustrated. The method 300 is described below in conjunction with its performance in the system 100, with some blocks being performed by the client devices 108, and other blocks being performed by the authentication server 116.

At block 305, the server 116 is configured to store, e.g., in the repository 144, account identifiers and associated authentication data for the operator 110 and any other operators provisioned in the system 100. The account identifiers can include enterprise-associated email addresses, user names, or the like. Each account identifier corresponds to a particular operator 110. The authentication data can include a password (e.g., obfuscated via hashing or the like), one or more vectors corresponding to biometric data of the operator, or the like. The authentication data stored in the repository 144 can also be referred to as reference authentication data, in that authentication data provided by a person (via a client device 108) purporting to hold the corresponding account identifier must match the reference authentication data in order to successfully authenticate that person.

The server 116 can also store device identifiers corresponding to the client devices 108, such as serial numbers, media access control (MAC) addresses, or the like. The server 116 can store various other information in association with the account identifiers, such as permissions associated with the corresponding operator 110 (e.g., which areas of the facility, and/or which enterprise applications, the operator 110 is permitted to access). The server 116 can also store various other information in association with the device identifiers, such as version indicators for applications installed on each client device 108 (e.g., the applications 168 and/or 172), areas of the facility to which each device 108 is assigned, and the like. The account identifiers, authentication data, device identifiers and the like, can be provisioned in the repository 144 during deployment of the server 116 for the facility, and periodically updated, e.g., in response to the hiring of new operators, the addition of client devices 108 to the pool of share client devices, and the like.

To begin using a client device 108, the operator 110 can select a client device 108 from a shared pool of devices 108, such as a charging dock or the like. The operator 110 can also, in this implementation, obtain a token identifier. For example, the operator 110 can retrieve a wristband from a supply disposed near the shared pool of devices 108. A wide variety of other mechanisms for obtaining a client device 108 and a token 120 can also be implemented, and the selection of a client device 108 need not be made at or near the same time as the selection of a token 120. In some examples, the tokens 120 (e.g., when implemented as wristbands, adhesive badges, or the like) can be generated on demand rather than provided as a previously-produced supply.

In order to log in to the selected client device 108 and gain access to enterprise applications thereon (e.g., via the application 172), the operator 110 may be prompted to authenticate with the client device 108. The client device 108 can be, for example via execution of the application 172, prompt the operator 110 to enter authentication data or a token identifier. In this example, given that the operator 110 is in possession of a token 120, the operator 110 can present the token 120 to the client device 108 for capture via the sensor 164. For example, the operator 110 can place the token 120 in the field of view of the sensor 164 and at block 310, the client device 108 can capture the token ID 212 from the token 120. Capturing the token ID 212 can include capturing an image of the data carrier 204 and decoding a barcode therein, executing an RFID read operation to retrieve the token ID 212, or the like. The client device 108 can determine whether the captured barcode or other data carrier 204 also includes the auxiliary identifier 216, and discard any data carriers 204 lacking the auxiliary identifier 216.

At block 312, the client device 108 is configured to determine whether local enrollment data containing the token ID obtained at block 310 exists, e.g., in the memory 152. Local enrollment data, as discussed below, is provided to client devices 108 following successful authentication of an operator and dynamic enrollment of a token ID 212 in connection with the operator. In this example, the operator has not previously used the token 120, and the determination at block 312 is therefore negative.

Following a negative determination at block 312, at block 315 the client device 108 is configured to determine whether enrollment data containing the token ID 212 from block 310 exists at the server 116. The device 108, in other words, can transmit a request to the server 116 via the network 112, the request containing at least the token ID 212, and in some examples an identifier of the device 108 itself. The request need not contain an account identifier or authentication data, as the client device 108 need not have prompted the operator 110 for such information at this stage. At block 320, the server 116 is configured to receive the token ID 212 in the request from the client device 108, and at block 325 the server 116 is configured to determine whether the token ID 212 has been enrolled (e.g., associated with an account identifier).

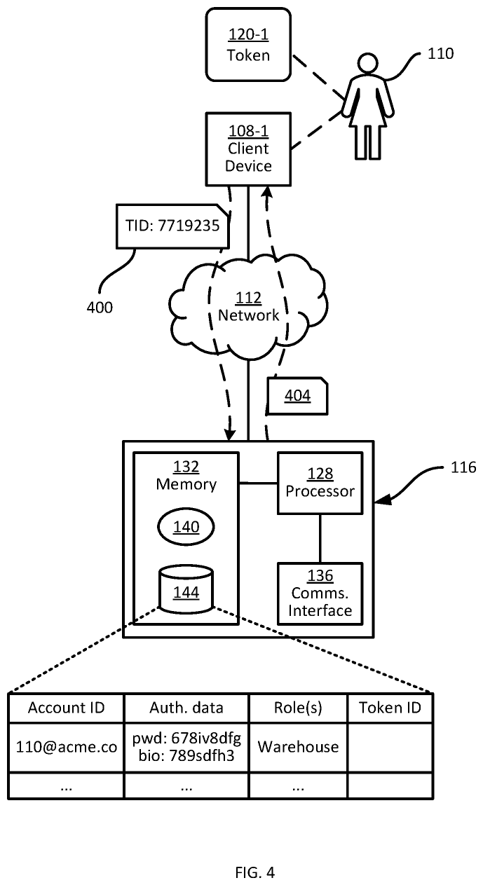

Turning to FIG. 4, an example performance of blocks 305, 310, 312, 315, 320, and 325 at set out above is illustrated. The operator 110 is shown having retrieved the token 120-1 (e.g., with the token identifier “7719235” encoded thereon), and the client device 108-1. The client device 108-1 captures the token ID “7719235” at block 310. Because the client device 108-1 does not have any local enrollment data, at block 315 the device sends a request 400 to the server 116 containing the token ID. At block 320, the server 116 receives the message 400, and at block 325 the server 116 determines whether the token ID “7719235” is enrolled in association with any account identifier in the repository 144.

As shown in FIG. 4, the repository 144 includes a record containing the account identifier “110@acme.com”, corresponding to the operator 110. The record includes authentication data corresponding to the operator 110, and can also indicate one or more roles assigned to the operator 110, which may define which areas of the facility, enterprise applications, or the like, can be accessed by the operator 110. In the illustrated example, the record does not contain token enrollment data. That is, the “Token ID” field of the record is empty. Further, in this example the remaining account records of the repository 144 also do not contain the token ID in the message 400. In other words, the token ID “7719235” is not currently associated with any account identifier. The determination at block 325 is therefore negative.

Returning to FIG. 3, at block 330, the server 116 is configured to request authentication data from the client device 108-1. For example, in response to a negative determination at block 325, the server 116 can send a command 404 to the client device 108-1 to prompt the operator 110 for authentication data (e.g., a user name and password, biometric data, or the like). At block 335, the client device 108-1 can generate a prompt on the display 160 requesting the authentication data. In some examples, the command 404 can indicate which authentication data is required, e.g., whether an account identifier and password are sufficient, or whether biometric data or a further authentication factor is to be collected. The operator 110 can enter authentication data, such as the account identifier “110@acme.co” and a password, and the client device 108 can transmit the account identifier and password to the server 116.

At block 340, the server 116 is configured to validate the authentication data received from the client device 108-1, e.g., by comparing the authentication data against the reference authentication data stored in association with the account identifier “110@acme.co” in the repository 144. If the authentication data provided by the client device 108-1 does not match the reference authentication data, performance of the method 300 can terminate, and the server 116 can transmit a message to the client device 108-1 (e.g., for presentation on the display 160) indicating that access is denied. When the authentication data from the client device 108-1 is valid, however, the server 116 generates token enrollment data. The token enrollment data associates the token ID with the account identifier, and can be stored in the repository 144.

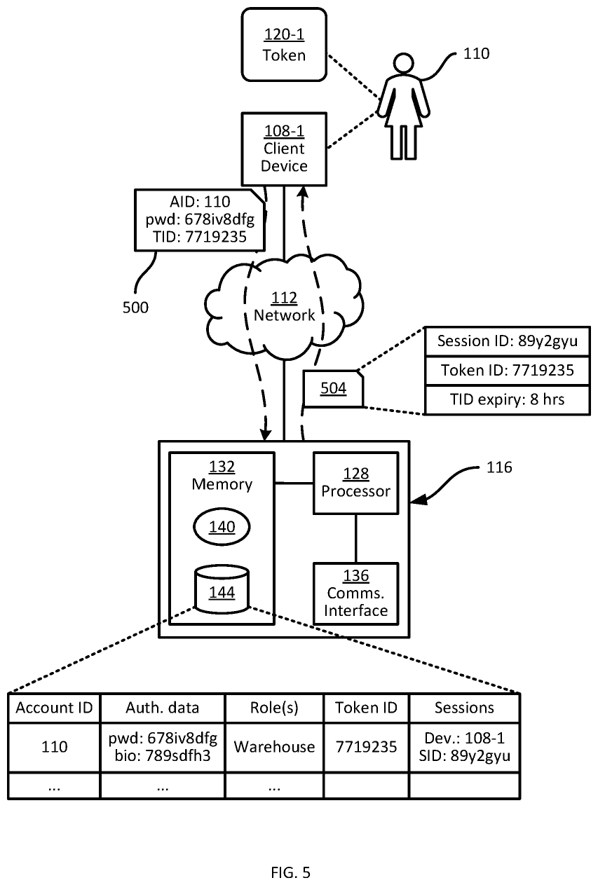

As shown in FIG. 5, at block 335 the device 108-1 transmits a message 500 containing the account identifier of the operator 110, as well as authentication data in the form of a password, and the previously captured token identifier. The server 116, upon validating the authentication data, generates token enrollment data by storing the token identifier in association with the account identifier. For example, in the implementation shown in FIG. 5, the server 116 stores the token ID “7719235” in the account record corresponding to the operator 110. In other examples, the token enrollment data can include a record distinct from the account records shown in FIG. 5, and containing both the token ID and the account ID.

The token enrollment data can also include other attributes, selected according to configuration settings at the server 116. For example, the server 116 can set an expiry timer for the token enrollment data, such that the association of the token 120-1 with the operator 110 expires after a period of time has elapsed. Expiry timers can be selected by the server 116 based on operator roles, in some examples (e.g., the “warehouse” role can be associated with an eight-hour expiry timer, while another role may be associated with a four-hour expiry timer).

Upon completion of block 340, the server 116 has dynamically enrolled the token identifier carried by the token 120-1 in association with the operator 110. As will be apparent from the discussion above, the association of the token 120-1 with the operator 110 required no pre-provisioning at the server 116 or the client device 108-1, and permitted the operator 110 to select a token 120 and client device 108 arbitrarily from the available devices 108 and tokens 120. Subsequently, as discussed in connection with the examples below, the operator 110 can employ the token 120-1 for authentication purposes, e.g., at the client device 108-1, or at other client devices 108. That is, the operator 110 may bypass the requirement to provide authentication data (e.g., a password and/or biometric data, or the like) under certain conditions, using the token 120-1. Authentication may therefore be less time-consuming for the operator 110, while the association between the operator 110 and the token 120-1 persists.

Referring again to FIG. 3, at block 345, the server 116 is configured to select and execute session control actions following the validation of authentication data for the operator 110 and generation of token enrollment data. The server 116 can select from a variety of session control actions, examples of which are described below. In the present example, the server 116 is configured to generate session data enabling the operator 110 to access the application server 104 via the client device 108-1. For example, the session data can include a session identifier and/or session key (e.g., an encryption key or the like), and may also include configuration settings such as an indication of whether the operator can initiate contemporaneous sessions at multiple client devices 108, and the like. The session data can also include the device identifier of the client device 108-1, as shown in the “Sessions” field of the repository 144 in FIG. 5.

The server 116 is also configured, in this example, to send the session data and the token enrollment data to the client device 108-1. For example, as shown in FIG. 5, the server 116 can send a message 504 to the client device 108-1 containing the session identifier, the token identifier, and a token expiry timer. The server 116 can also be configured, in some examples, to transmit the session data to the application server 104, permitting the application server 104 to determine whether to allow access by the operator 110 via the client device 108-1, for example in response to receipt of the token identifier from the client device 108-1. At block 350, the client device 108-1 is configured to receive and store the session ID, token ID, and token expiry timer for subsequent use. In some examples, the session data can also define additional timers and/or attributes for the expiry timer. For example, the session data can define a time period after which the device 108-1 is to lock and/or terminate the session if the token ID is not received via block 310 before the time period expires. In other words, the operator 110 can be required to present the token periodically to avoid locking or session termination.

At block 355, the client device 108-1 is configured to control access to the functions of the client device 108-1 and the application server 104 by the operator 110 according to the session data, until an indication is received that the session received at block 350 has been terminated, either by the operator 110, or via a command from the server 116. The client device 108-1 determines at block 360 whether the session has been terminated. When the determination is affirmative, at block 365 the device 108-1 discards the session and token enrollment data received in the message 504 from the memory 152. The client device 108-1 can also inform the server 116 that the session has terminated, and in response the server 116 can discard the session data. The server 116 may, however, retain the token enrollment data, if the token enrollment data has not expired. When the determination at block 360 is negative, session control continues at block 355.

Session control at the device 108-1 can include, for example, monitoring an activity status of the client device 108-1 (e.g., via an accelerometer, the display/touch screen assembly 160, or the like), and locking the device 108-1 in response to idle time exceeding a predetermined time period (e.g., one minute, although a wide variety of other idle time periods can also be implemented). Locking the device 108-1 does not terminate the session (e.g., the operator 110 may remain logged in and the session data shown in FIG. 5 may be retained at the server 116), but to unlock the device 108-1 and continue using the device 108-1, the operator 110 may be prompted to re-authenticate. To re-authenticate, the operator 110 can present the token 120-1 to the sensor 164, initiating a further performance of the method 300.

As will be apparent from the discussion above, when the device 108-1 captures the token ID “7719235” at block 310, the determination at block 312 is affirmative, and as shown in FIG. 3, the device 108-1 proceeds directly to block 355, bypassing the provision of authentication data for validation at the server 116. The operator 110 may therefore resume access to enterprise services via the client device 108-1 at block 355. As noted above, the token enrollment data may include a token expiry timer. If the token expiry timer elapses while the operator 110 is using the device 108-1 (e.g., before the operator 110 has logged out), the device 108-1 can be configured to discard the token enrollment data, while maintaining the session data.

The server 116, at block 370, is configured to determine whether the token enrollment data has expired, and when the determination is affirmative, to discard the token enrollment data at block 375. Thus, when a token enrollment has expired, the server 116 and any devices 108 storing that token enrollment data discard the corresponding token identifier, and continuing to use the associated token 120 involves repeating the enrollment process as set out above.

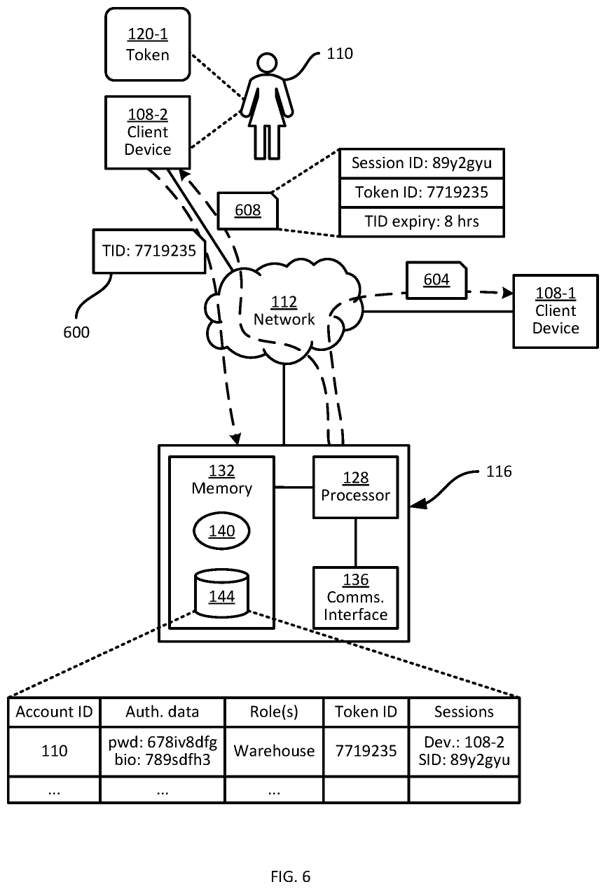

Turning to FIG. 6, a further example performance of the method 300 is illustrated, in which the operator 110 has selected the client device 108-2, e.g., abandoning the client device 108-1. When the operator 110 presents the token 120-1 to the client device 108-2, the determination at block 312 is negative, but the determination at block 315 is positive. Specifically, following transmission of a message 600 containing the token ID to the server 116, and receipt of the message 600 by the server 116 at block 320, the determination at block 325 at the server 116 is affirmative, because the token ID “7719235” remains associated with the operator 110. The server 116 therefore proceeds to block 345, bypassing the need to prompt the operator 110 for further authentication data. At block 345, the server 116 can, for example, select session control actions including sending a command 604 to the device 108-1 to terminate the session at the device 108-1 and discard session and token enrollment data. In response to receiving a termination message, the client device 108-1 can generate a notification (e.g., via the display 160 or other output device) indicating to an operator thereof that the session has been terminated. The session control actions can also include retrieving and sending the session and token enrollment data to the device 108-2 in a message 608, as well as updating the session data in the repository 144 to reflect that the session is now associated with the device 108-2 rather than the device 108-1. In other words, the performance of block 345 at the server 116 can lead to a performance of block 350 at the device 108-2, and an affirmative determination at block 360 for the device 108-1. In this example, the device 108-1 is de-associated with the account identifier, and the device 108-2 is associated with the account identifier. Access to a service, application, or the like (e.g., at the server 104) can thereby be transferred from the device 108-1 to the device 108-2.

Various other session control actions can also be executed by the server 116 at block 345. For example, if a previously un-enrolled token ID is received at block 320, and the authentication data received at block 340 corresponds to the operator 110, the server 116 can be configured to discard the previous enrollment data associated with the operator 110, and generate new token enrollment data. The system 100, in other words, permits the operator 110 to select a new token 120, e.g., if a previous token 120 is damaged or lost.

In still further examples, the server 116 may receive a previously un-enrolled token identifier from a client device 108 associated with an active session. The server 116 can prompt the client device 108 for authentication data, and if the authentication data is validated for a distinct operator than the operator associated with the current session, the server 116 may, at block 345, deny access to the operator (e.g., because the device 108 is already in use by another operator). The server 116 can, however, retain the enrollment data generated at block 340, permitting the operator that attempted to access one client device to access a different client device by bypassing the requirement to provide authentication data.

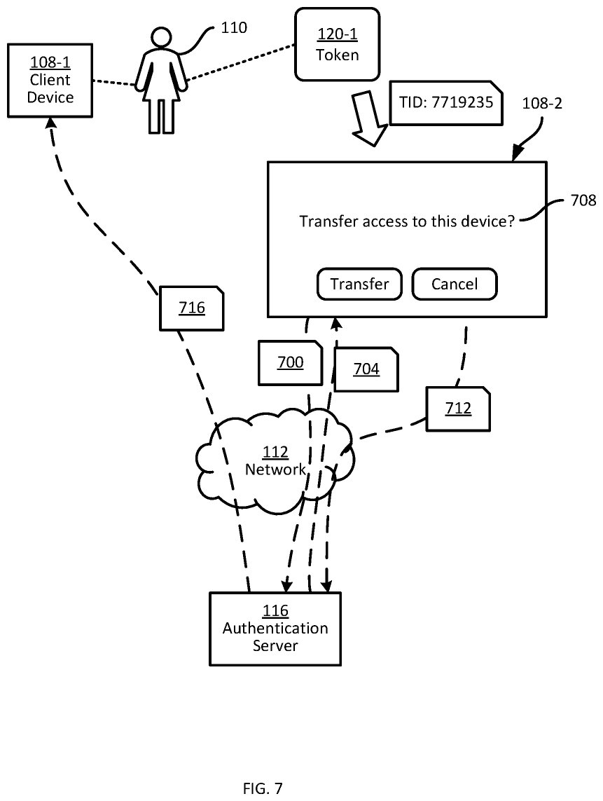

In further examples, the session control actions performed by the server 116 at block 345 can include instructing a client device 108 to prompt the operator 110 prior to transferring access from one client device 108 to another client device 108. For example, referring to FIG. 7, the operator 110 is authenticated via the client device 108-1, and the client device 108-1 may therefore store enrollment data as described above. The client device 108-1 may, for example, be a smartphone or the like, authenticated to access a streaming media service (e.g., a television service, or the like). The client device 108-2 may be a television or other large-format device (e.g., a projector). To access the service via the client device 108-2, the operator 110 can present the token 120-1 to the client device 108-2.

In response to obtaining the token identifier (at block 310), the client device 108-2 can make a negative determination at block 312, having no locally-stored enrollment data corresponding to the token 120-1. At block 315, the device 108-2 can send a request 700 to the server 116, containing the token ID, as described above in connection with the request 400 shown in FIG. 4. The server 116 can receive the token ID at block 320, and make an affirmative determination at block 325. At block 345, prior to de-associating the client device 108-1 from the account identifier of the operator 110 and from the token ID, the server 116 can send an instruction to the device 108-2 to generate a prompt 708, e.g., on the display 160 of the device 108-2. The prompt 708 requests confirmation, e.g., from the operator 110, that the operator 110 wishes to transfer access to the service from the device 108-1 to the device 108-2. The prompt 708 can include affirmative (e.g., “Transfer”) and negative (e.g., “Cancel”) options selectable by the operator 110 via a suitable input device (e.g., a remote control, touch screen, microphone, or the like).

The device 108-2 can receive a command, e.g., via selection of the “Transfer” option by the operator 110, to transfer access to the service to the device 108-2, from the device 108-1. In response to the command, the device 108-2 can obtain token enrollment data, e.g., by sending a request 712 to the server 116 to transfer the enrollment data currently associating the client device 108-1 with the operator 110 (e.g., with the account identifier of the operator 110). The server 116 can respond to the request by transmitting the enrollment data to the device 108-2. The server 116 can also, in some examples, transmit a de-association command 716 to the device 108-1, e.g., instructing the device 108-1 to discard locally-stored enrollment data corresponding to the operator 110. The device 108-1, the device 108-2, or both, can further be configured to present notifications (e.g., on their respective displays 160) indicating that access has been transferred.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method, comprising:
storing an account identifier and authentication data associated with the account identifier;
receiving, from a client computing device, a token identifier;
requesting the authentication data from the client computing device;
in response to receiving the authentication data, generating token enrollment data associating the token identifier with the account identifier; and
transmitting the token enrollment data for storage in association with the client computing device.

2. The method of claim 1, further comprising:
prior to requesting the authentication data from the client device, determining that the token identifier is not associated with the account identifier.

3. The method of claim 1, wherein the token enrollment data configures the client computing device to bypass collection of the authentication data for granting access to a function of the client computing device, in response to a subsequent capture of the token identifier.

4. The method of claim 1, wherein generating the token enrollment data includes:
storing the token identifier in association with the account identifier.

5. The method of claim 4, wherein generating the token enrollment data further includes:
selecting an expiry timer for the token enrollment data;
determining whether the expiry timer is elapsed; and
discarding the token enrollment data when the expiry timer is elapsed.

6. The method of claim 1, further comprising:
storing session data associating the account identifier with an identifier of the client computing device.

7. The method of claim 6, further comprising:
receiving the token identifier from a second client device;
transmitting the token enrollment data to the second client device; and
updating the session data to de-associate the account identifier from the client computing device, and associate the account identifier with the second client computing device.

8. The method of claim 7, further comprising:
transmitting a command to the client computing device to terminate access for the account identifier, and to discard the token enrollment data.

9. A computing device, comprising:
a communications interface; and
a processor configured to:
store an account identifier and authentication data associated with the account identifier;
receive, from a client computing device, a token identifier;
request the authentication data from the client computing device;
in response to receiving the authentication data, generate token enrollment data associating the token identifier with the account identifier; and
transmit the token enrollment data for storage in association with the client computing device.

10. The computing device of claim 9, wherein the processor is further configured to:
prior to requesting the authentication data from the client device, determine that the token identifier is not associated with the account identifier.

11. The computing device of claim 9, wherein the token enrollment data configures the client computing device to bypass collection of the authentication data for granting access to a function of the client computing device, in response to a subsequent capture of the token identifier.

12. The computing device of claim 9, wherein the processor is configured to generate the token enrollment data by:
storing the token identifier in association with the account identifier.

13. The computing device of claim 12, wherein the processor is configured to generate the token enrollment data by:
selecting an expiry timer for the token enrollment data;
determining whether the expiry timer is elapsed; and
discarding the token enrollment data when the expiry timer is elapsed.

14. The computing device of claim 9, wherein the processor is further configured to:
store session data associating the account identifier with an identifier of the client computing device.

15. The computing device of claim 14, wherein the processor is further configured to:
receive the token identifier from a second client device;
transmit the token enrollment data to the second client device; and
update the session data to de-associate the account identifier from the client computing device, and associate the account identifier with the second client computing device.

16. The computing device of claim 15, wherein the processor is further configured to:
transmit a command to the client computing device to terminate access for the account identifier, and to discard the token enrollment data.

17. A computing device, comprising:
a communications interface;
an output device; and
a processor configured to:
obtain a token identifier and token enrollment data;
determine that the token identifier is associated with a second computing device authenticated to access a service using an account identifier;
generate a prompt via the output device;
receive, via the prompt, a command to transfer access to the service from the second computing device to the computing device;
in response to the command,
access the service using the token enrollment data.

18. The computing device of claim 17, wherein the processor is configured to determine that the token identifier is associated with the second computing device by:
sending a request containing the token identifier to an authentication server; and
receiving a reply indicating that the token identifier is enrolled in association with the second computing device.

19. The computing device of claim 17, wherein the processor is further configured to obtain the token enrollment data by:
sending a request to an authentication server to transfer the token enrollment data from the second computing device to the computing device; and
receiving the token enrollment data from the authentication server in response to the request.
